(19) United States
(12) Patent Application Publication
(10) Pub. No.: US 2018/0170272 A1
(43) Pub. Date: Jun. 21, 2018

(54) LADDER MOUNTING SYSTEM

(71) Applicant: Mike Bleazard, Holden, UT (US)

(72) Inventor: Mike Bleazard, Holden, UT (US)

(21) Appl. No.: 15/844,913

(22) Filed: Dec. 18, 2017

Related U.S. Application Data
(60) Provisional application No. 62/436,003, filed on Dec. 19, 2016.

(51) Int. Cl. B60R 9/048; E06C 5/24

(52) U.S. Cl. CPC B60R 9/0485; E06C 5/24

(57) ABSTRACT

A ladder mounting system includes a mounting bracket assembly having a top-bracket including a top-bracket-body, a first-section, and a second-section, at least one bottom-bracket, a bottom-bracket-body, and a substantially u-shaped clip. The mounting bracket assembly may be attached to a stationary-ladder on a recreational vehicle and support an additional item such as a ladder on the stationary-ladder. The device provides convenience and peace of mind to users by allowing them to quickly and easily secure a multitude of items to their stationary-ladder.

### CROSS REFERENCE TO RELATED APPLICATION

The present application is related to and claims priority to U.S. Provisional Patent Application No. 62/436,003 filed Dec. 19, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of mounting brackets and more specifically relates to ladder mounting brackets.

### 2. Description of Related Art

Many people enjoy traveling in RV's. A recreational vehicle (RV) is a motor vehicle or trailer equipped with living space and amenities found in a home. RV's usually have an attached ladder leading to the roof for accessing various components. Some ladders are portable, and commonly made of metal, wood, or fiberglass. Many RV owners attempt to attach items to the existing ladder on their camper, trailer, motor home, etc. This may include stepladders, carpets, and any other item they would like to travel with. However, securing these items to the ladder can be difficult. Typically, bungee cords and ropes are used, however, the metal on the cords has a tendency to scratch the RV, causing damage. In addition, these attachment methods are not reliable and can result in a loss of property while driving. A suitable solution is desired.

U.S. Pat. No. 7,210,559 to David R. Hickey relates to an apparatus and method for holding/locking a ladder or other object to a structure. The described apparatus and method for holding/locking a ladder or other object to a structure includes a heavy-duty apparatus for holding or locking a ladder or other object in place, say, to a vehicle, such as a van and its rack and/or a rack mounted on a camper top of a pickup truck. The apparatus has a fixed portion and a movable portion which can engage the rings of a ladder and/or a one or more piece of large sheet material in place.

### BRIEF SUMMARY OF THE INVENTION

In view of the foregoing disadvantages inherent in the known mounting brackets art, the present disclosure provides a novel ladder mounting system. The general purpose of the present disclosure, which will be described subsequently in greater detail, is to provide a secure method of attaching a stepladder or other items to the already existing ladder on an RV.

A ladder mounting system is disclosed herein. The ladder mounting system includes a mounting bracket assembly having a top-bracket (including a top-bracket-body, a first-section, and a second-section), and at least one bottom-bracket (having a bottom-bracket-body, and a substantially u-shaped clip). The device is configured to mount at least one item such as a ladder to a stationary-ladder on a recreational vehicle. The first-section and the second-section are ‘paralleling’, the first-section and the second-section having opposite open ends. The first-section is configured to receive a stationary-ladder-rung of a stationary-ladder on a recreational vehicle and support the top-bracket on the stationary-ladder-rung of the stationary ladder. The second-section is configured to receive a top-plate of a ladder and support the ladder. The second-section comprises a depth suitable for receiving a back side of the top-plate of the ladder.

The at least one bottom-bracket includes the substantially u-shaped clip having a first-tab and a second-tab, the first-tab is configured to wrap around a rear of the stationary-ladder-rung to a top side of the stationary-ladder-rung and support the at least one bottom-bracket on the stationary-ladder-rung on the stationary-ladder. The second-tab is positioned on a front of the stationary-ladder-rung during an in-use condition and is configured to further support a ladder on the stationary-ladder. The second-tab of the at least one bottom-bracket further comprises an aperture. The second-tab vertically extends along the front of the stationary-ladder-rung. The mounting bracket assembly is configured to provide support for mounting at least one item to the stationary-ladder of the recreational vehicle.

A kit is also disclosed herein including a set of instructions, the top-bracket, the bottom-bracket, and the at least one bungee cord. The kit may be used to mount a plurality of objects including but not limited to a ladder.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a ladder mounting system, constructed and operative according to the teachings of the present disclosure.

FIG. 1 is a perspective view of the ladder mounting system during a ready for use condition, according to an embodiment of the disclosure.

FIG. 2 is a perspective view of the ladder mounting system of FIG. 1, during an ‘in-use’ condition, according to an embodiment of the disclosure.

FIG. 3 is a front perspective view of the ladder mounting system of FIG. 1, according to an embodiment of the present disclosure.

FIG. 4 is a front perspective view of the ladder mounting system of FIG. 1, according to an embodiment of the present disclosure.

FIG. 5 is a front perspective view of the ladder mounting system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to mounting brackets and more particularly to a ladder mounting system as used to improve the safety of ladder mounting for travel.

Generally, the present invention provides a secure method of attaching a stepladder to the already existing ladder on an RV. It allows RV owners to safely and securely attach a variety of items to the existing ladder. This effectively eliminates the need to use bungee cords, ropes, and other items to attach objects to the ladder. It prevents a loss of property or damage to the RV due to inefficient securement methods. The present invention affords convenience and peace of mind to users by allowing them to quickly and easily secure a multitude of items to their stationary ladder.

Ladder mounting system provides consumers with a safe and secure method of attaching a stepladder or other desired item to the existing ladder of an RV. The device is comprised of a top bracket and two bottom brackets made from polypropylene. The top bracket may be about 3″ wide and snaps onto the stationary ladder that is installed on the RV. The top of a stepladder slides into the bracket. The bottom brackets snap securely into place onto the bottom of the stationary ladder to allow the bottom of the stepladder or item being attached to be secured in place. Two included bungees may be used to secure the item to the brackets at the bottom of the ladder. A multitude of items can be secured using this method.

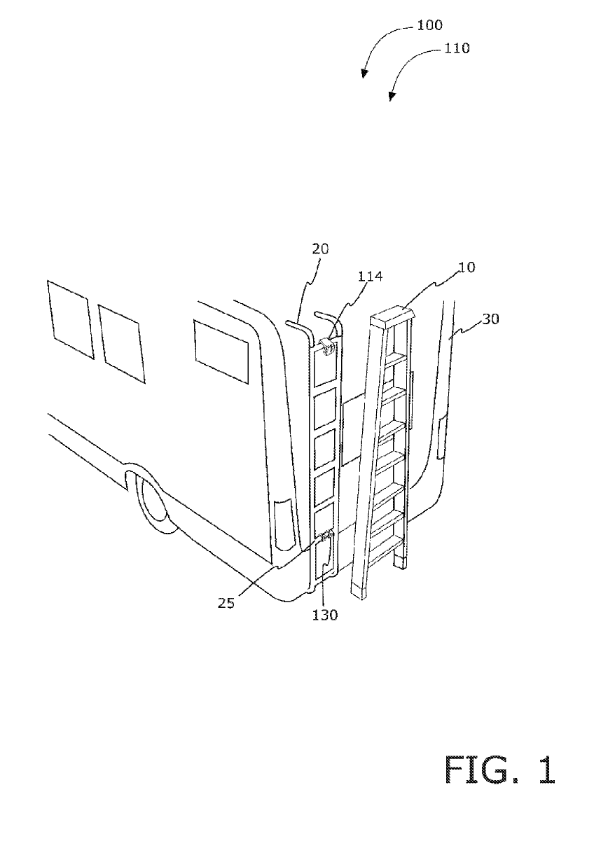

Referring now more specifically to the drawings by numerals of reference, there is shown in FIGS. 1-5, various views of a ladder mounting system 100. FIG. 1 shows a ladder mounting system 100, during a ready for use condition according to an embodiment of the present disclosure. As illustrated, the ladder mounting system 100 may include a mounting bracket assembly 110 having a top-bracket 114 including a top-bracket-body 118, a first-section 120, and a second-section 124, at least one bottom-bracket 130, a bottom-bracket-body 134, and a substantially u-shaped clip 138. The device is configured to mount at least one item such as a ladder 10 to a stationary-ladder 20 on a recreational vehicle 30.

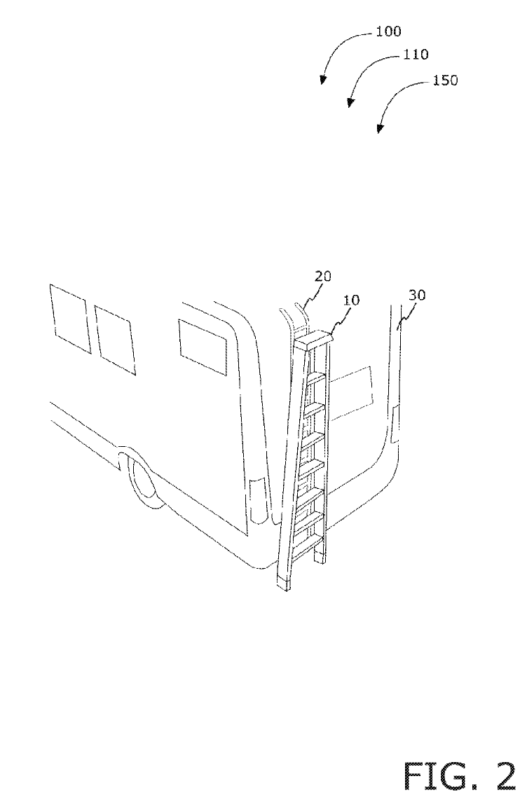

FIG. 2 shows a perspective view of the ladder mounting system 100 of FIG. 1, during an ‘in-use’ condition 150 according to an embodiment of the present disclosure. As above, the ladder mounting system 100 may include the mounting bracket assembly 110 having the top-bracket 114 including the top-bracket-body 118, the first-section 120, and the second-section 124, the at least one bottom-bracket 130, the bottom-bracket-body 134, and the substantially u-shaped clip 138. The first-section 120 and the second-section 124 are paralleling; the first-section 120 and the second-section 124 having opposite open ends. The first-section 120 is configured to receive a stationary-ladder-rung 25 of a stationary-ladder 20 on a recreational vehicle 30 and support the top-bracket 114 on the stationary-ladder-rung 25 of the stationary ladder 20.

The first-section 120 comprises a first-section-width substantially similar to a width of the stationary-ladder-rung 25 such that when the stationary-ladder-rung 25 is received the stationary-ladder-rung 25 is friction fitted within and further supported by the tab. The first-section-width is approximately 3 inches. The second-section 120 is configured to receive a top-plate 15 of a ladder 10 and support the ladder 10. The second-section 124 comprises a depth suitable for receiving a back side of the top-plate 15 of the ladder 10.

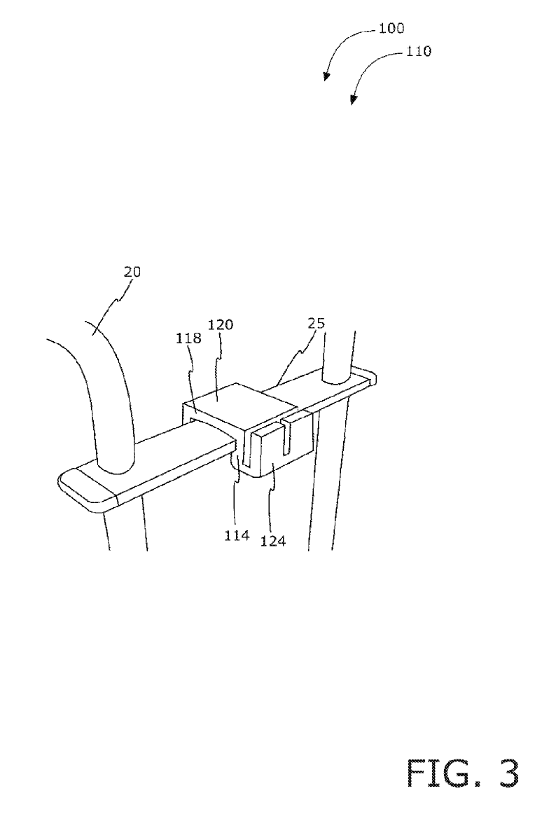

FIG. 3 shows a perspective view of the ladder mounting system 100 of FIG. 1, according to an embodiment of the present disclosure. As above, the ladder mounting system 100 may include the top-bracket 114 and at least one bottom-bracket 130. The at least one bottom-bracket 130 includes the substantially u-shaped clip 138 having a first-tab 139 and a second-tab 140; the first-tab 139 is configured to wrap around a rear of the stationary-ladder-rung to a top side of the stationary-ladder-rung 25 and support the at least one bottom-bracket 130 on the stationary-ladder-rung 25 on the stationary-ladder 20. The second-tab 140 is positioned on a front of the stationary-ladder-rung 25 during an in-use condition and is configured to further support a ladder 10 on the stationary-ladder 20. The second-tab 140 of the at least one bottom-bracket 134 further comprises an aperture 141. The second-tab 140 vertically extends along the front of the stationary-ladder-rung. The mounting bracket assembly is configured to provide support for mounting at least one item to the stationary-ladder 25 of the recreational vehicle 30.

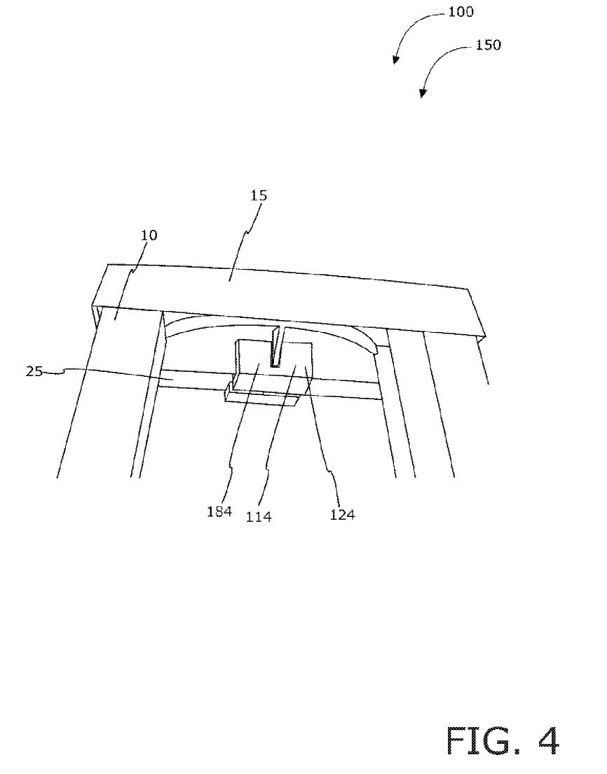

Referring now to FIG. 4 showing a perspective view of the ladder mounting system 100 of FIG. 1, according to an embodiment of the present disclosure. As above, the ladder mounting system 100 may include the mounting bracket assembly 110 having the top-bracket 114 including the top-bracket-body 118, the first-section 120, and the second-section 124, the at least one bottom-bracket 130, the bottom-bracket-body 134, and the substantially u-shaped clip 138. The second-section 124 further comprises a channel for receiving an underside portion of the top-plate 15 of the ladder 10. The channel of the second-section 124 comprises a width configured to friction-fittedly receive the back side of the top-plate 15 of the ladder 10. The second-section 124 comprises a depth suitable for receiving a back side of the top-plate 15 of the ladder 10. The top-bracket 114 and the at least one bottom-bracket 130 are semi-rigid. The top-bracket 114 and the at least one bottom-bracket 130 are configured to snap fit to the stationary-ladder-rung 25. The top-bracket 114 further comprises a tab for securing to an underside of the stationary-ladder-rung 25.

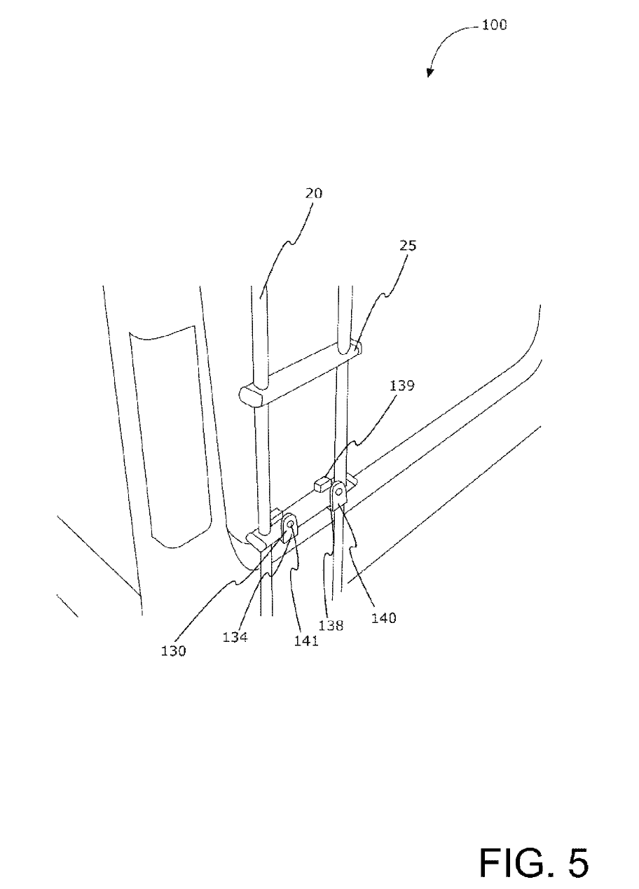

FIG. 5 shows a front perspective view of the ladder mounting system 100 of FIG. 1, according to an embodiment of the present disclosure. As above, the ladder mounting system 100 may include the top-bracket 114 and at least one bottom-bracket 130. In a preferred embodiment, the mounting bracket assembly 110 may comprise two of the at least one bottom-bracket 130. The at least one bottom-brackets 130 oppose one another on the stationary-ladder-rung 25 during the in-use condition. The top-bracket 114 and the at least one bottom-bracket 130 may comprise polypropylene, or other suitable materials. The top-bracket 114 if configured in a middle-section of the stationary-ladder-rung 25 during the in-use condition. The mounting bracket assembly 110 may further include at least one bungee cord to further secure the at least one item such as a ladder 10.

According to one embodiment, the ladder mounting system 100 may be arranged as a kit. In particular, the ladder mounting system 100 may further include a set of instructions, a top-bracket 114, at least one bottom-bracket 130, and at least one bungee cord. The instructions may detail functional relationships in relation to the structure of the ladder mounting system 100 such that the ladder mounting system 100 can be used, maintained, or the like, in a preferred manner

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ladder mounting system comprising:
a mounting bracket assembly having;
a top-bracket including;
a top-bracket-body;
a first-section; and
a second-section;
at least one bottom-bracket having;
a bottom-bracket-body; and
a substantially u-shaped clip;
wherein said first-section and said second-section are paralleling, said first-section and said second-section having opposite open ends;
wherein said first-section is configured to receive a stationary-ladder-rung of a stationary-ladder on a recreational vehicle and support said top-bracket on said stationary-ladder-rung of said stationary ladder;
wherein said second-section is configured to receive a top-plate of a ladder and support said ladder;
wherein said second-section comprises a depth suitable for receiving a back side of said top-plate of said ladder;
wherein said at least one bottom-bracket includes said substantially u-shaped clip having a first-tab and a second-tab, said first-tab is configured to wrap around a rear of said stationary-ladder-rung to a top side of said stationary-ladder-rung and support said at least one bottom-bracket on said stationary-ladder-rung on said stationary-ladder;
wherein said second-tab is positioned on a front of said stationary-ladder-rung during an in-use condition and is configured to further support a ladder on said stationary-ladder; and
wherein said mounting bracket assembly is configured to provide support for mounting at least one item to said stationary-ladder of said recreational vehicle.

2. The ladder mounting system of claim 1, wherein said second-section further comprises a channel for receiving an underside portion of said top-plate of said ladder.

3. The ladder mounting system of claim 1, wherein said top-bracket and said at least one bottom-bracket are semi-rigid.

4. The ladder mounting system of claim 3, wherein said top-bracket and said at least one bottom-bracket are configured to snap fit to said stationary-ladder-rung.

5. The ladder mounting system of claim 1, wherein said top-bracket further comprises a tab for securing to an underside of said stationary-ladder-rung.

6. The ladder mounting system of claim 1, wherein said mounting bracket assembly comprise two of said at least one bottom-bracket.

7. The ladder mounting system of claim 6, wherein said at least one bottom-bracket oppose one another on said stationary-ladder-rung during said in-use condition.

8. The ladder mounting system of claim 3, wherein said top-bracket and said at least one bottom-bracket comprise polypropylene.

9. The ladder mounting system of claim 1, wherein said second-tab of said at least one bottom-bracket further comprises an aperture.

10. The ladder mounting system of claim 9, wherein said second-tab vertically extends along said front of said stationary-ladder-rung.

11. The ladder mounting system of claim 2, wherein said second-section comprises a depth suitable for receiving a back side of said top-plate of said ladder.

12. The ladder mounting system of claim 5, wherein said first-section comprises a first-section-width substantially similar to a width of said stationary-ladder-rung such that when said stationary-ladder-rung is received said stationary-ladder-rung is friction fitted within and further supported by said tab.

13. The ladder mounting system of claim 12, wherein said first-section-width is approximately 3 inches.

14. The ladder mounting system of claim 1, wherein said top-bracket if configured in a middle-section of said stationary-ladder-rung during said in-use condition.

15. The ladder mounting system of claim 11, wherein said channel of said second-section comprises a width configured to friction-fittedly receive said back side of said top-plate of said ladder.

16. The ladder mounting system of claim 1, wherein said mounting bracket assembly further comprises at least one bungee cord to further secure said at least one item.

17. A ladder mounting system, the ladder mounting system comprising:
a mounting bracket assembly having;
a top-bracket including;
a top-bracket-body;
a first-section; and
a second-section;
at least one bottom-bracket including;
a bottom-bracket-body; and
a substantially u-shaped clip;
wherein said top-bracket and said at least one bottom-bracket are semi-rigid;
wherein said top-bracket and said at least one bottom-bracket comprise polypropylene;
wherein said top-bracket and said at least one bottom-bracket are configured to snap fit to said stationary-ladder-rung;
wherein said first-section and said second-section are paralleling, said first-section and said second-section having opposite open ends;
wherein said first-section is configured to receive a stationary-ladder-rung of a stationary-ladder on a recreational vehicle and support said top-bracket on said stationary-ladder-rung of said stationary ladder;
wherein said first-section comprises a first-section-width substantially similar to a width of said stationary-ladder-rung such that when said stationary-ladder-rung is received said stationary-ladder-rung is friction fitted within and further supported by said tab;
wherein said first-section-width is approximately 3 inches;
wherein said top-bracket further comprises a tab for securing to an underside of said stationary-ladder-rung;
wherein said top-bracket if configured in a middle-section of said stationary-ladder-rung during said in-use condition;
wherein said second-section is configured to receive a top-plate of a ladder and support said ladder;
wherein said second-section comprises a depth suitable for receiving a back side of said top-plate of said ladder;
wherein said second-section comprises a depth suitable for receiving a back side of said top-plate of said ladder;
wherein said second-section further comprises a channel for receiving an underside portion of said top-plate of said ladder;
wherein said channel of said second-section comprises a width configured to friction-fittedly receive said back side of said top-plate of said ladder;
wherein said mounting bracket assembly comprise two of said at least one bottom-bracket;
wherein said at least one bottom-bracket oppose one another on said stationary-ladder-rung during said in-use condition;
wherein said at least one bottom-bracket includes said substantially u-shaped clip having a first-tab and a second-tab, said first-tab is configured to wrap around a rear of said stationary-ladder-rung to a top side of said stationary-ladder-rung and support said at least one bottom-bracket on said stationary-ladder-rung on said stationary-ladder;
wherein said second-tab is positioned on a front of said stationary-ladder-rung during an in-use condition and is configured to further support a ladder on said stationary-ladder;
wherein said second-tab of said at least one bottom-bracket further comprises an aperture;
wherein said second-tab vertically extends along said front of said stationary-ladder-rung;
wherein said mounting bracket assembly further comprises at least one bungee cord to further secure said at least one item; and
wherein said mounting bracket assembly is configured to provide support for mounting at least one item to said stationary-ladder of said recreational vehicle.

18. The ladder mounting system of claim 17, further comprising:
a set of instructions;
said top-bracket;
said bottom-bracket; and
said at least one bungee cord;
wherein the ladder mounting system is arranged as a kit.
